(19) United States
(12) Patent Application Publication
(10) Pub. No.: US 2004/0201361 A1
(43) Pub. Date: Oct. 14, 2004

(54) Charging system for robot

(75) Inventors: Won-Jun Koh, Suwon city (KR); Ki-Cheol Park, Hwasung city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/706,990

(22) Filed: Nov. 14, 2003

(30) Foreign Application Priority Data
Apr. 9, 2003 (KR) 2003-22367

(51) Int. Cl. H02J 7/00

(52) U.S. Cl. 320/104

(57) ABSTRACT

A charging system to charge a battery of a robot includes a charger and a first charging part provided in the charger and including a high-frequency current generator to rectify commercial power and to convert the rectified power into a high-frequency square wave signal, a primary induction coil to generate an electromagnetic field by the high-frequency square wave signal supplied from the high-frequency current generator, and a first terminal part to emit the electromagnetic field created by the primary induction coil. The charging system also includes a second charging part provided in a robot and including a second terminal part to mate with the first terminal part, a secondary induction coil to generate an induced current by the electromagnetic field emitted from the first charging part, and a DC converter to rectify the induced current generated from the secondary induction coil and to supply DC power to the battery. Accordingly, the present invention provides the charging system for the robot, which charges the battery of the robot without electrical contact between the robot and a charger.

### CROSS-REFERENCE TO RELATED APPLICATIONS

This application claims the benefit of Korean Patent Application No. 2003-22367, filed Apr. 9, 2003, in the Korean Intellectual Property Office, the disclosure of which is incorporated herein by reference.

### BACKGROUND OF THE INVENTION

1. Field of the Invention

The present invention relates to a charging system for a robot, and more particularly, to a charging system to change a battery of a robot.

2. Description of the Related Art

In an industrial field, a robot is generally employed for loading or carrying goods. A working radius in which the robot travels to work is relatively wide, and the robot is cordlessly powered by an internal battery. Thus, there is a need to keep charging the battery.

A battery charging method for the robot is disclosed in Korean Patent Publication No. 1997-583. The robot checks whether or not the internal battery needs to be charged. If the robot determines that the internal battery needs to be charged, the robot travels toward a charger, with a light receiving part to receive an optical signal from a light emitting part attached to the charger. When the robot electrically contacts the charger, the charger starts charging the internal battery of the robot.

However, in the conventional charging system in which the robot receives power from the charger through an electrical contact terminal, the electrical contact terminal of the robot or the charger is generally exposed to the outside, and therefore is likely to be shorted by a conductor such as copper and water. The conductor may thereby damage the battery and an internal circuit of the robot. Further, if the contact terminal is designed such that it is not exposed to the outside, there exists a problem in that a location of the contact terminal is limited to a place such as a bottom of the robot.

Meanwhile, in the conventional charging system, there is also a problem in that a position of the robot should be precisely controlled because the battery is charged only when the contact terminal of the robot precisely contacts the contact terminal of the charger.

### SUMMARY OF THE INVENTION

Accordingly, it is an aspect of the present invention to provide a charging system for a robot, which charges a battery of the robot without having electrical contact between the robot and a charger.

Another aspect of the present invention is to provide a charging system for a robot, which charges a battery of the robot even if a position of the robot is not precisely controlled.

Additional aspects and/or advantages of the invention will be set forth in part in the description which follows and, in part, will be obvious form the description, or may be learned by practice of the invention.

The foregoing and/or other aspects of the present invention are achieved by providing a charging system to charge a battery of a robot, which includes a charger, a first charging part provided in the charger and including a high-frequency current generator to rectify commercial power and to convert the rectified power into a high-frequency square wave signal, a primary induction coil to generate an electromagnetic field by the high-frequency square wave signal supplied from the high-frequency current generator, and a first terminal part to emit the electromagnetic field created by the primary induction coil, and a second charging part provided in a robot and including a second terminal part to mate with the first terminal part, a secondary induction coil to generate an induced current by the electromagnetic field emitted from the first charging part, and a DC converter to rectify the induced current generated from the secondary induction coil and to supply DC power to the battery.

According to an aspect of the invention, the first terminal part includes a terminal member movable relative to the charger, and an elastic member interposed between the terminal member and the charger.

According to an aspect of the invention, the second terminal part includes a terminal member movable relative to the robot, and an elastic member interposed between the terminal member and the robot.

According to another aspect of the invention, the second terminal part and the first terminal part include a protrusion and a protrusion accommodating part, respectively.

According to an aspect of the invention, at least one of the protrusion and the protrusion accommodating part is provided with guiding slants.

According to an aspect of the invention, the protrusion is accommodated in the protrusion accommodating part, leaving a margin in which the protrusion is movable in a direction transverse to a docking direction.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a control block diagram of a charging system for a robot, according to an embodiment the present invention;

FIG. 2 is a schematic view of the charging system for the robot of FIG. 1;

FIG. 3 is a schematic view illustrating a state in which the robot of FIG. 2 physically contacts with a charger being biased in a direction of “A”; and

FIG. 4 is a schematic view illustrating a state in which the robot of FIG. 2 physically contacts the charger, being angled.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

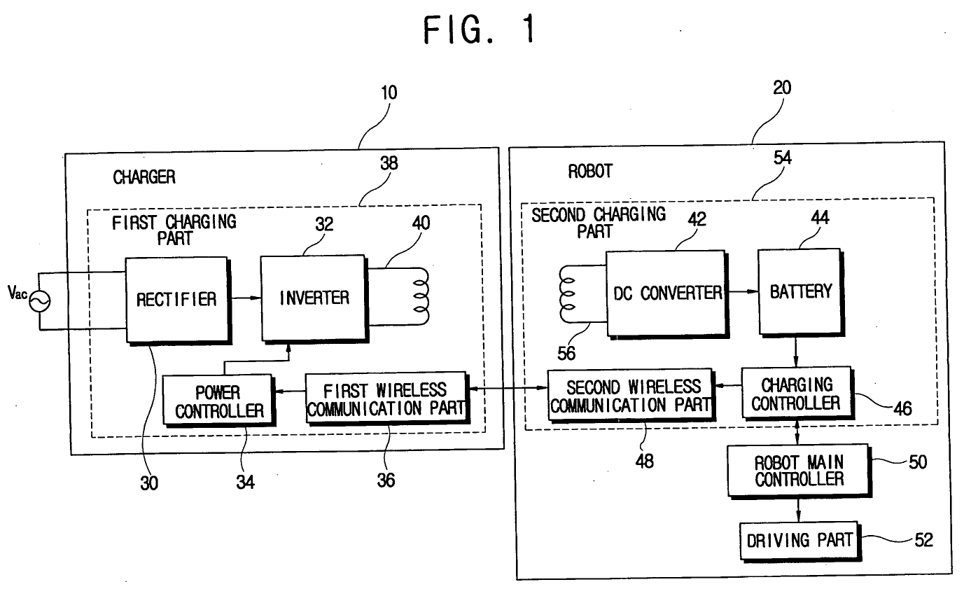

As shown in FIG. 1, a charging system for a robot includes a charger 10, and a first charging part 38 provided in the charger 10 and including a high-frequency current generator with a rectifier 30 to rectify commercial power supplied from the outside and an inverter 32 to convert the power rectified by the rectifier 30 into a high-frequency square wave signal, a primary induction coil 40 to generate an electromagnetic field by the high-frequency square wave signal supplied from the inverter 32, and a first terminal part to emit the electromagnetic field created by the primary induction coil 40. The charging system includes a second charging part 54 provided in a robot 20 and including a second terminal part to be accommodated in the first terminal part, a secondary induction coil 56 to generate an induced current by the electromagnetic field emitted from the first charging part 38, and a DC (direct current) converter 42 to rectify the induced current generated from the secondary induction coil 56 and to supply DC power to a battery 44.

The first charging part 38 provided in the charger 10 further includes a first wireless communication part 36 to communicate with the robot 20, and a power controller 34 to control the inverter 32 in response to a control signal transmitted from a charging controller 46 (to be described later) through the wireless communication part 36.

The second charging part 54 provided in the robot 20 further includes a second wireless communication part 48 to communicate with the charger 10, and the charging controller 46 to control the power controller 34 provided in the charger 10 by control of a robot main controller 50.

The rectifier 30 rectifies a commercial AC (alternating current) power into a DC voltage. The rectifier 30 includes a bridge diode and a smoothing capacitor. The bridge diode rectifies the commercial AC power into the DC voltage and the smoothing capacitor makes the rectified DC voltage smooth.

The inverter 32 includes a switching element (not shown) such as a transistor. The switching element is switched on/off in response to a control signal of the power controller 34. An operation of the switching element causes an output voltage of the rectifier 30 to be converted into the high-frequency square wave signal. As the high-frequency square wave signal is applied to the primary induction coil 40, the primary induction coil 40 generates a magnetic field.

The first wireless communication part 36 is employed for data communication between the charger 10 and the robot 20, and, for example, includes a local RF (radio frequency) communication module.

The power controller 34 preferably includes a microcomputer to switch on/off the switching element of the inverter 43 so as to control a current flowing in the primary induction coil 40. When the power controller 34 receives a charging start signal from the charging controller 46 through the first wireless communication part 36, the power controller 34 controls the switching element to be switched on/off. Then, the current flowing in the primary induction coil 40 creates the magnetic field in the primary induction coil 40. Further, when the power controller 34 receives a charging complete signal through the first wireless communication part 36, the power controller 34 turns off the switching element and prevents the current from flowing in the primary induction coil 40.

Here, when the first terminal part of the charger 10 physically contacts the second terminal part of the robot 20, the primary induction coil 40 of the charger 10 is near the secondary induction coil 56 of the robot 20.

Further, the electromagnetic field generated in the primary induction coil 40 of the charger 10 induces the current in the secondary induction coil 56 of the robot 20. Then, the induced current is converted into the DC current by the DC converter 42.

The DC converter 42 includes a voltage regulator, which converts the induced AC power into the DC power, regulates the DC power for the robot 20, and supplies the voltage to the battery 44.

The second wireless communication part 48 includes the local RF communication module, and is employed for data communication between the charger 10 and the robot 20.

When it is determined that there is a need to charge the battery 44 as a result of sensing a battery state by a battery state sensor (not shown), the charging controller 46 transmits the determination to the robot main controller 50. Then, the robot main controller 50 controls a driving part 52 to move the robot 20 toward the charger 10. The robot main controller 50 controls the movement of the robot 20 by transmitting and receiving an optical signal. Further, the robot main controller 50 controls the charging controller 46 to transmit a charging control signal to the power controller 34 through the second wireless communication part 48.

A battery protection circuit may be provided to protect the battery 44 from an over-voltage and an over-current, which is not illustrated in the accompany drawings.

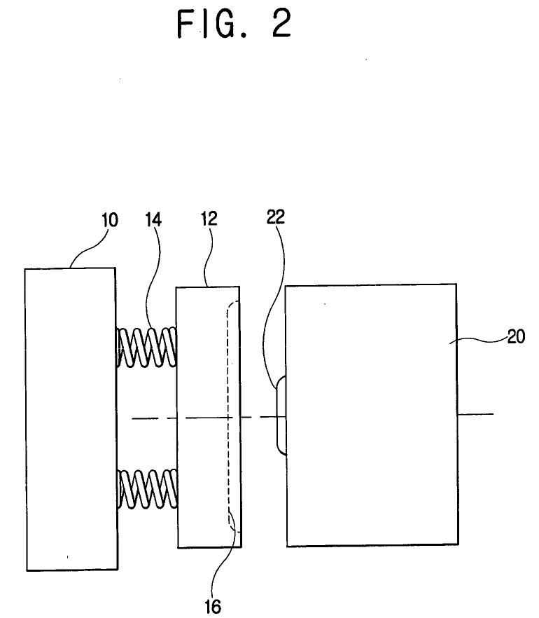

As shown in FIG. 2, the first terminal part of the charger 10 includes a terminal member 12 movable relative to the charger 10, and an elastic member 14 interposed between the terminal member 12 and the charger 10. Further, the second terminal part of the robot 20 includes a protrusion 22.

The terminal member 12 is provided with a protrusion accommodating part 16 to accommodate the protrusion 22 therein. Here, the protrusion 22 is accommodated in the protrusion accommodating part 16, leaving a margin in which the protrusion 22 is movable in a direction transverse to a docking direction. Therefore, even though a position of the robot 20 is not precisely controlled, the robot 20 may physically contact the charger 10, being biased within an allowable error. Thus, it is possible to charge the battery 44 of the robot 20. Here, the allowable error defines a position at which the electromagnetic field generated by the primary induction coil 40 of the charger 10 induces the current in the secondary induction coil 56 of the robot 20.

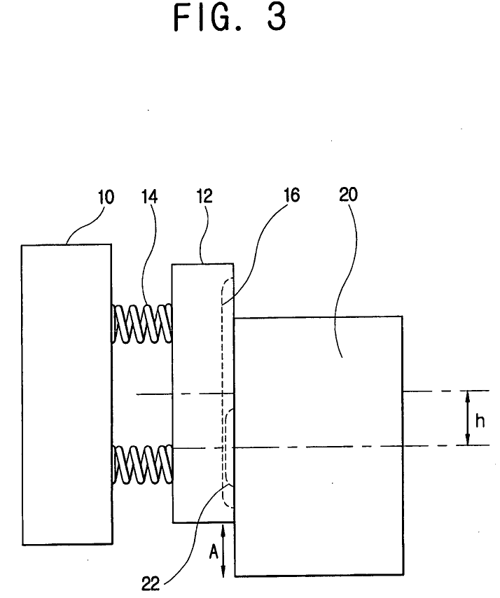

For example, as shown in FIG. 3, when the robot 20 physically contacts the charger 10, being biased against a line aligning the robot 20 with the charger 10 by a position error of “h” within the allowable error in a direction of “A” (left and right), the protrusion accommodating part 16 of the charger 10 may accommodate the protrusion 22 of the robot 20.

Further, in the charging system for the robot according to the present invention, the protrusion 22 is accommodated in the protrusion accommodating part 16, leaving a margin in which the protrusion 22 is movable in a direction vertical to the docking direction considering the position error in up and down directions occurring when the charger 10 is installed or when the protrusion 22 is mounted to the robot 20. Therefore, the robot 20 may physically contact the charger 10, being biased by the position error in the up and down directions.

The protrusion 22 and the protrusion accommodating part 16 are provided with guiding slants along the docking direction, respectively. Therefore, the protrusion 22 is easily accommodated in the protrusion accommodating part 16.

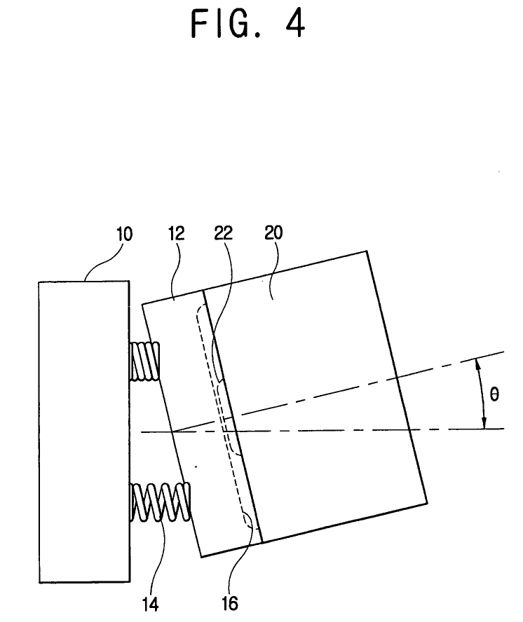

The elastic member 14 preferably includes a spring, which is elastically deformed and absorbs a shock when the protrusion 22 is accommodated in the protrusion accommodating part 16. As shown in FIG. 4, when the robot 20 physically contacts the charger 10, being angled against a line aligning the robot 20 with the charger 10 at an angle of “θ” in which the position of the robot 20 is not precisely controlled, the elastic member 14 is elastically deformed. Therefore, the protrusion 22 of the robot 20 is accommodated in the protrusion accommodating part 16, so that the robot 20 physically contacts the charger 10 within the charging position.

An operation of the charging system for the robot according to the present invention will be described hereinbelow.

First, the charging controller 46 determines whether or not there is a need to charge the battery 44 based on the battery state sensed by the battery state sensor. When a sensed voltage level of the battery 44 is below a predetermined voltage level, the charging controller 46 transmits the determination to the robot main controller 50. Then, the robot main controller 50 controls the driving part 52 to move the robot 20 toward the charger 10, thereby accommodating the protrusion 22 of the robot 20 in the protrusion accommodating part 16 of the terminal member 12. At this time, the protrusion 22 is accommodated in the protrusion accommodating part 16, leaving a margin in which the protrusion 22 is movable in a direction transverse to a docking direction, and with the elastic member 14 being elastically deformable. Therefore, even though the robot 20 physically contacts the charger 10, being biased and angled against the line aligning the robot 20 with the charger 10 in which the position of the robot 20 is not precisely controlled, the protrusion 22 may be accommodated in the protrusion accommodating part 16.

After the robot 20 physically contacts the charger 10, the charging controller 46 transmits the charging control signal to the charger 10 through the second wireless communication part 48. Then, the power controller 34 of the charger 10 receives the charging control signal through the first wireless communication part 36. The power controller 34 controls the inverter 32 to apply the high-frequency square wave signal to the primary induction coil 40, thereby causing the primary induction coil 40 to generate the electromagnetic field. Then, the electromagnetic field of the primary induction coil 40 induces the AC current in the secondary induction coil 56. The AC current is converted by the DC converter 42 into the DC current, thereby supplying the DC current to the battery 44.

Thereafter, when the battery 44 is completely charged, the charging controller 46 transmits a power turn-off signal to the power controller 34 through the second wireless communication part 48, to thereby stop charging the battery 44.

Further, the charging controller 46 transmits the charging complete signal to the robot main controller 50, and then the robot main controller 50 controls the driving part 52 to release the protrusion 22 from the protrusion accommodating part 16.

Thus, the battery 44 of the robot 20 may be charged without precisely controlling the position of the robot 20. At this time, because the battery 44 is charged by the induced current due to the electromagnetic field without electrical contact, the robot 20 including the battery 44 is protected from such damage that may be caused by the shorted electrical contact terminal of the conventional charging system.

Further, because there is no need of an electrical contact terminal, the robot 20 may be designed without regard to the electrical contact terminal. Thus, the charging system of the present invention may be compatible with similar modeled robots.

In the above-described embodiment, the terminal member 12 and the elastic member 14 are provided in the first terminal part of the charger 10. However, the terminal member and the elastic member may be provided in the second terminal part of the robot 20.

In the above-described embodiment, the second terminal part has the protrusion 22, and the first terminal part has the protrusion accommodating part 16 to accommodate the protrusion 22 therein. However, the second terminal part may have the protrusion accommodating part, and the first terminal part may have the protrusion.

In the above-described embodiment, both the protrusion 22 and the protrusion accommodating part 16 are provided with the guiding slants. However, either of the protrusion 22 and the protrusion accommodating part 16 may be provided with the guiding slant, or neither of the protrusion 22 and the protrusion accommodating part 16 may be provided with the guiding slant.

As described above, in the charging system according to the present invention, the electromagnetic field generated in the primary induction coil 40 of the charger 10 causes the secondary induction coil 56 of the robot 20 to generate the induced current, thereby supplying a charging voltage to the battery 44. Further, the charging system according to the present invention includes the protrusion 22 and the protrusion accommodating part 16, so that not only the robot 20 may contact the charger 10 within the charging position even if the position of the robot 20 is not precisely controlled, but also the battery 44 of the robot 20 may be charged without the electrical contact.

As described above, the present invention provides a charging system for a robot, which charges a battery of the robot without electrical contact between the robot and a charger.

Further, the present invention provides a charging system for a robot, which charges a battery of the robot even if the position of the robot is not precisely controlled.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A charging system to charge a battery of a robot, comprising:
a charger;
a first charging part provided in the charger and including a high-frequency current generator to rectify commercial power and to convert the rectified power into a high-frequency square wave signal, a primary induction coil to generate an electromagnetic field by the high-frequency square wave signal supplied from the high-frequency current generator, and a first terminal part to emit the electromagnetic field created by the primary induction coil; and
a second charging part provided in the robot and including a second terminal part to mate with the first terminal part, a secondary induction coil to generate an induced current by the electromagnetic field emitted from the first charging part, and a DC converter to rectify the induced current generated from the secondary induction coil and to supply DC power to the battery.

2. The charging system according to claim 1, wherein the first terminal part comprises:
a terminal member movable relative to the charger; and
an elastic member interposed between the terminal member and the charger.

3. The charging system according to claim 1, wherein the second terminal part comprises:
a terminal member movable relative to the robot; and
an elastic member interposed between the terminal member and the robot.

4. The charging system according to claim 1, further comprising:
a protrusion and a protrusion accommodating part provided in the second terminal part and the first terminal part, respectively.

5. The charging system according to claim 4, wherein at least one of the protrusion and the protrusion accommodating part is provided with guiding slants.

6. The charging system according to claim 4, wherein the protrusion is accommodated in the protrusion accommodating part, leaving a margin in which the protrusion is movable in a direction transverse to a docking direction.

7. The charging system according to claim 2, further comprising:
a protrusion and a protrusion accommodating part provided in the second terminal part and the first terminal part, respectively.

8. The charging system according to claim 7, wherein at least one of the protrusion and the protrusion accommodating part is provided with guiding slants.

9. The charging system according to claim 7, wherein the protrusion is accommodated in the protrusion accommodating part, leaving a margin in which the protrusion is movable in a direction transverse to a docking direction.

10. The charging system according to claim 3, further comprising:
a protrusion and a protrusion accommodating part provided in the second terminal part and the first terminal part, respectively.

11. The charging system according to claim 10, wherein at least one of the protrusion and the protrusion accommodating part is provided with guiding slants.

12. The charging system according to claim 10, wherein the protrusion is accommodated in the protrusion accommodating part, leaving a margin in which the protrusion is movable in a direction transverse to a docking direction.

13. The charging system according to claim 1, further comprising:
a charging controller provided in the second charging part to transmit a control signal to the charger.

14. The charging system according to claim 13, wherein the first charging part further comprises:
a first wireless communication part to allow communication between the charger and the robot; and
a power controller to control an inverter of the high-frequency current generator in response to the control signal transmitted from the charging controller through the first wireless communication part.

15. The charging system according to claim 14, wherein the second charging part further comprises:
a second wireless communication part to communicate with the charger,
wherein the charging controller controls the power controller through the second wireless communication part.

16. The charging system according to claim 8, wherein the elastic member comprises:
a spring elastically deformable to absorb shocks when the protrusion is accommodated in the protrusion accommodating part.

17. The charging system according to claim 11, wherein the elastic member comprises:
a spring elastically deformable to absorb shocks when the protrusion is accommodated in the protrusion accommodating part.

18. The charging system according to claim 4, wherein the protrusion is accommodated in the protrusion accommodating part, leaving a margin in which the protrusion is movable in a direction vertical to a docking direction.

19. The charging system according to claim 7, wherein the protrusion is accommodated in the protrusion accommodating part, leaving a margin in which the protrusion is movable in a direction vertical to a docking direction.

20. The charging system according to claim 10, wherein the protrusion is accommodated in the protrusion accommodating part, leaving a margin in which the protrusion is movable in a direction vertical to a docking direction.

21. The charging system according to claim 4, wherein the protrusion and the protrusion accommodating part are provided so that the robot contacts the charger within a charging position even if a position of the robot is not precisely controlled.

22. The charging system according to claim 21, wherein the battery of the robot is charged even when the position of the robot is not precisely controlled.

23. The charging system according to claim 7, wherein the protrusion and the protrusion accommodating part are provided so that the robot contacts the charger within a charging position even if a position of the robot is not precisely controlled.

24. The charging system according to claim 23, wherein the battery of the robot is charged even when the position of the robot is not precisely controlled.

25. The charging system according to claim 10, wherein the protrusion and the protrusion accommodating part are provided so that the robot contacts the charger within a charging position even if a position of the robot is not precisely controlled.

26. The charging system according to claim 25, wherein the battery of the robot is charged even when the position of the robot is not precisely controlled.

27. The charging system according to claim 1, wherein the battery of the robot is charged without electrical contact between the robot and the charger.

28. The charging system according to claim 1, further comprising:
a protrusion and a protrusion accommodating part provided in the first terminal part and the second terminal part, respectively.

29. A charging system to charge a battery of a robot, comprising:
a charger;
a first charging unit provided in the charger to generate an electromagnetic field, and including a first terminal part to emit the electromagnetic field; and
a second charging part provided in the robot and including a second terminal part to mate with the first terminal part, to generate an induced current by the electromagnetic field emitted from the first charging part, supplying power to the battery.

30. The charging system according to claim 29, further comprising:
a protrusion and a protrusion accommodating part provided in the second terminal part and the first terminal part, respectively.

31. The charging system according to claim 30, wherein the protrusion is accommodated in the protrusion accommodating part, leaving a margin in which the protrusion is movable in a direction transverse to a docking direction.

32. The charging system according to claim 30, wherein the protrusion is accommodated in the protrusion accommodating part, leaving a margin in which the protrusion is movable in a direction vertical to a docking direction.

33. A charging system having a charger to charge a battery of a robot, comprising:
a first charging unit provided in the charger to generate an electromagnetic field, and including a first terminal part to emit the electromagnetic field; and
a second charging part provided in the robot and including a second terminal part to mate with the first terminal part, to generate an induced current by the electromagnetic field emitted from the first charging part, supplying power to the battery,
wherein the battery of the robot is charged without electrical contact between the robot and the charger.
